(19) United States
(12) Patent Application Publication
(10) Pub. No.: US 2004/0250435 A1
(43) Pub. Date: Dec. 16, 2004

(54) Tile spacer for positioning tiles during installation

(76) Inventor: Tony Mark Fiore, Keysborough Victoria (AU)

Correspondence Address: BIRCH STEWART KOLASCH & BIRCH, PO BOX 747, FALLS CHURCH, VA, 22040-0747, US

(21) Appl. No.: 10/492,820

(22) PCT Filed: Oct. 17, 2002
(86) PCT No.: PCT/AU02/01410

(30) Foreign Application Priority Data
Oct. 17, 2001 (AU) PR 8316
Jan. 2, 2002 (AU) PR 9794

(51) Int. Cl. G01D 21/00

(52) U.S. Cl. 33/527

(57) ABSTRACT

A tile spacer (10′) comprises a support portion (12′) adapted to overlie, preferably contact, at lease one tile with a lower face (20′) of the support portion opposed to an exposed face of the tile or tiles, and a plurality of individual first tile separator elements (14′) carried by the support portion and projecting downwardly relative to said lower face (20′). Each of the first tile separator elements (14′) is spaced from the other element or elements (14′) and has opposite surfaces which abuts opposed edges of adjacent tiles in use to space said tiles. The spaces (10′) may also have opposed second tile spacer elements (16′) that are used to space tiles in a corner. A method of use of the tile spacer is also disclosed.

### FIELD OF THE INVENTION

The present invention relates generally to the laying of tiles and is particularly concerned with a tile spacer for positioning tiles as they are being laid, as well as with a method of laying a tile.

### BACKGROUND OF THE INVENTION

A primary concern of tile installers is the positioning and alignment of an individual tile in relation to other laid tiles. Misalignment of a tile can not only cause problems with the positioning of subsequent tiles, it can also severely affect the aesthetic appearance of the entire tiled surface.

The process of laying tiles on floors, walls, ceilings, bench tops and the lice typically involves positioning tiles, or a series of tiles glued to a mesh, individually on to a surface to which an adhesive or some form of mortar has previously been applied. For convenience only, both synthetic tile adhesive and mortar for bonding tiles will hereinafter be referred as adhesive or tile adhesive. When the tiles are being positioned, tile spacers are typically used to assist in aligning the tiles relative to each other and to provide consistent inter-tile spacing. Tile spacers most commonly used for this purpose are in the shape of a cross. In use, such tile spacers are inserted between the tiles at the intersection defined by four tile corners. Each cross member of the tile spacer acts to separate two of the four tiles and, with all cross members having the same width, they also provide for a uniform inter-tile space between each adjacent pair of tiles. In a similar fashion, a T-shaped spacer can be used to position three tiles in an offset layup, or two tiles in a linear layup.

While the cross-shaped tile spacers are effective in tile positioning and providing uniform inter-tile spacing, they present several problems to tile installers. In particular, for most tiling applications, the size of the spacers is quite small which makes them difficult to handle and locate into the correct position. Also, as the spacers are inserted at least substantially wholly between the intersecting tiles, retrieving the spacers can be difficult. This is especially the case if the tiles have been overglazed so that a lip is formed around the top of the tiles.

Retrieval of a tile spacer is particularly important. If the spacer remains between the tiles, grout that is subsequently applied to fill the gap between the tiles is not likely to adhere effectively in these regions. To avoid disturbing the tile positioning and spacing, the tile spacers are typically removed when the adhesive has just set. In circumstances where the tiles must be walked upon to remove the spacers, the adhesive should be well set. In either situation, removal of the spacer is made more difficult by the spacer becoming adhered to the adhesive. This it particularly likely to occur when the adhesive beneath the tiles is squeezed into the gap between the tiles as the tiles are correctly positioned.

Several modified versions of the conventional cross-shaped tile spacer have been proposed. For example, in U.S. Pat. No. 5,359,783 a cross-shaped tile spacer with a handle extending from the intersection of the cross members is disclosed. The addition of the handle may assist in removal of spacers that have become weakly adhered to the tile adhesive, but such a modification is unlikely to assist in the removal of strongly adhered spacers or a spacer that is trapped beneath a lip formed by an overglazed tile. Furthermore, the large surface area defined by the cross members predisposes the spacer to becoming strongly adhered to the adhesive. Although the cross members have thin depending pins which are intended to penetrate the tile adhesive and support the cross members clear of the adhesive, the cross members are shaped and designed to be received between adjacent tiles at an intersection to space the tiles from each other. Thus, when adhesive is squeezed from beneath the tiles into the gap between the tiles as the tiles are positioned, it will tend to adhere along the full length of the cross members.

U.S. Pat. No. 5,288,534 discloses a disk shaped platform from which a cross-shaped tile spacing element projects. In use, the cross-shaped tile spacing element functions to position and space tiles in a similar way to a conventional cross-shaped spacer. The disk shaped platform also has a function during use. When the cross-shaped tile spacing element is positioned at an intersection between four tiles, the platform portion of the spacer contacts a corner of the exposed surface of each tile at the intersection and thereby limits the projection of the cross-shaped tile spacing element into the inter-tile gap. By this design, the platform portion of the spacer can act as a handle to assist in the removal of the spacing element. In addition, the platform can be used to ensure that tiles extend in a common plane at the corners, i.e. that they have been laid flat.

However, this design has several disadvantages. Like the aforementioned “cross-shaped” tile spacers, the large surface area of the spacing element predisposes the spacer to become strongly adhered to the tile adhesive.

It would therefore be desirable to provide a tile spacer that is easy to handle and alleviates the difficulty of removing the spacer when it becomes adhered to tile adhesive.

### SUMMARY OF THE INVENTION

Accordingly, the present invention provides a tile spacer comprising:

a support portion adapted to overlie at least one tile with a lower face of the support portion opposed to an exposed face of the at least one tile, and

a plurality of individual first tile separator elements carried by the support portion and projecting downwardly relative to said lower face,

wherein each of said first tile separator elements is spaced from the other first tile separator element or elements and has opposite surfaces which abut opposed edges of adjacent tiles in use to space said tiles.

The present invention also provides a method of laying a tile on a support surface which comprises applying adhesive to one or both of a contact surface of the tile and the support surface, adhering the tile contact surface to the support surface, spacing the tile on the support surface relative to an adjacent surface by means of a tile spacer comprising a support portion that overlies the tile with a lower face of the support portion opposed to an exposed face of the tile, said exposed face being opposite the contact surface, and a plurality of spaced individual first tile separator elements carried by the support portion and projecting downwardly relative to said lower face with at least one of said first tile separator elements having opposite surfaces that respectively abut a side edge of the tile and said adjacent surface, and removing the tile spacer.

By providing the first tile separators as spaced individual elements, it is readily possible to design the separator elements with a reduced surface area compared to the aforementioned tile spacers that may become bonded to the tile adhesive, thereby facilitating their removal from the adhesive. Furthermore, by ensuring that the support portion cannot be received in the gap(s) between the tiles, by virtue of its size or shape, the support portion can limit the projection of the individual first separator elements into the gap(s) and can act as a handle for removing the tile spacer once the tile adhesive has set.

It will be appreciated by the reader that the terms “overlie”, “lower face” and “downwardly” are relative. When the tile spacer is oriented for use in spacing tiles being laid on a floor, bench, or other upwardly facing horizontal surface the lower face of the support portion will face generally downwardly and the separator elements will project downwardly. However, when the tile spacer is oriented to use in spacing tiles on a ceiling or other downwardly facing horizontal surface, the lower face of the support portion will face generally upwardly and the separator elements will project upwardly. Similarly, when the tile spacer is used on a vertical wall, the lower face of the support portion will face generally towards the wall and the separator elements will project towards the wall. Thus, the tile spacer is defined in a particular orientation but it will be appreciated that the spacer can adopt different orientations.

The tile spacer of the present invention has at least two spaced first tile separator elements carried by the support portion and projecting downwardly relative to the lower face of the support portion. The precise number is unimportant to the invention but will be selected according to the number and arrangement of tiles to be separated from each other by the tile spacer. Thus, a tile spacer with two first separator elements may be used to space two tiles from each other, one tile from a wall or one tile from a corner of a wall; a file spacer with three first separator elements may space two tiles from each other and from a wall or one or more previously-laid tiles; and a tile spacer with four first separator elements may be used at the intersection of four tiles, with one first separator element between each adjacent pair of tiles. The most common shape of tile is rectangular, but if, for example, the tile spacer is to be used with triangular tiles the tile spacer may have an appropriate number of first separator elements to be used at an intersection of the tiles. Preferably, the tile spacer has one first separator element to be received between each pair of opposed edges of adjacent tiles and/or between an edge of a tile and an adjacent wall surface. This will assist to minimise the potential contact area with the tile adhesive. However, it will be appreciated that in some circumstances, such as separating two tiles with one tile spacer, two first separator elements will be desirable.

The first separator elements will have a shape to define the minimum spacing between adjacent tiles, and this dimension is hereinafter referred to as the width of the first separator elements. The first separator elements will also have a dimension which extends along the opposed edges of adjacent tiles, and this is hereinafter referred to as the length of the first separator elements. The first separator elements will additionally have a dimension defining the extent to which they project downwardly relative to the lower face, and this dimension is hereinafter known as the height of the first separator elements.

The desired separation or gap between adjacent tiles is partly a function of the size of the tiles, that is aesthetic appearance, and the width of the first separator elements will be selected accordingly. Generally, the width will be in the range of from 1 to 15 mm, more usually 1 to 10 mm, and for most uses between about 1.5 and about 5 mm.

The length of the first separator elements is preferably selected to minimise the longitudinal extent of the first separator elements to be received between adjacent tiles while providing sufficient strength to define the spacing and to be removed by applying force to the support portion. Preferably, the length of each first separator element is no greater than twice its width and most preferably it is no greater than the width.

While the height of the first separator elements could be such as to support the tile spacer on the floor or other surface on which the tiles are being laid with the at least one tile between that surface and the support portion, this is likely to mean that the first separator elements will be received in the tile adhesive. Preferably, the first separator elements have a height such that with the support portion abutting the exposed face of the at least one tile in the desired orientation of the tile, the first separator elements are spaced from the surface on which the tile or tiles are laid. More preferably, the first separator elements do not project beyond the opposite face to the exposed surface or surfaces of the tile or tiles. In most embodiments, the first separator elements may have a height of no more than about 10 mm, for example about 6 mm.

It will be appreciated from the above that the first separator elements may take any desired shape. For example, they may be in the form of pins, lugs, knobs or-the like. The first separator elements may have a tapered length and/or may be inclined. If they are inclined, the height of the first separator elements is defined by their perpendicular extent downwardly away from the lower face of the support portion, that is the extent from which they can project between adjacent tiles. Preferably, the first separator elements extend parallel to each other and are in the form of cylindrical pins of circular cross section.

Advantageously, the first separator elements project from the lower face of the support portion, but this is not essential. They could, for example, extend from a side face or a respective side face of the support portion and project downwardly relative to the lower face therefrom.

The lower face of the support portion is preferably planar, but this is not essential. Instead, the lower face could provide only one or more reduced contact areas for abutting the exposed surface of the tile or tiles that the support portion overlies, (if the height of the first separator elements permits this), compared to the overall area of the support portion.

The support portion may have any desired shape to accommodate the first separator elements that extend therefrom and allow the support portion to overlie the at least one tile. For example, the support portion may be circular to accommodate any number of separator elements, D-shaped or semicircular to accommodate two or three separator elements, or even elongate to accommodate two separator elements. Other shapes are of course possible, including oval, rectangular, triangular, square and polygonal.

Advantageously, the support portion is hollow, and most preferably defines an annulus of the desired shape from which the separator elements extend. This not only reduces the material from which the tile spacer is formed, but also permits the tile edges or corners to be viewed through the support portion.

The tile spacer may include a handle to facilitate the removal of the first separator elements from between tiles. When the support portion is in the form of an annulus, at least one reinforcing bridge may be provided across the annulus. If such a reinforcing bridge has a reduced thickness or depth compared to the support portion, such that at least the tips of the fingers can be received between the exposed surface of the tile or tiles and the reinforcing bridge, the bridge can act as a convenient handle. Preferably the upper face of the support portion is at least substantially planar.

The tile spacer conveniently further includes one or more second tile separator elements that project laterally outwardly from the support portion. Such a second tile separator element can readily be used to space a tile when it is inconvenient to utilise the plurality of first separator elements. Advantageously, the second tile separator element or elements extend from a respective laterally outer face of the support portion.

Preferably the tile spacer has two second tile separator elements that project laterally outwardly in opposite directions from the support portion. This arrangement facilitates the tile spacer being used to space pairs of tiles that are being laid on adjacent surfaces that define an internal corner.

The width of the second tile separator element or elements is preferably the same as that of the first tile separator elements, and the height may also be substantially the same or slightly greater. Preferably, the second tile separator element(s) has a square or round cross section so that it can readily be used in different orientations, and in one embodiment it has the same depth and shape of the upper and lower faces as the support portion.

The tile spacer may be formed of any rigid or semi rigid material, preferably semi rigid plastics such as polyethylene, polypropylene, nylon, polyvinyl chloride, and copolymers thereof. The tile spacer is advantageously injection moulded, but it may be formed by any suitable means.

### BRIEF DESCRIPTION OF THE DRAWINGS

Various embodiments of a tile spacer in accordance with the present invention will now be described by way of example only with reference to the accompanying drawings, in which:

FIG. 1 is a perspective view from above of a first embodiment of the tile spacer;

FIG. 2 is a plan view from below of the tile spacer of FIG. 1.

FIG. 3 is a sectional view line 3-3 of FIG. 1.

FIG. 4 is a perspective view of a second embodiment of the tile spacer; and

FIG. 5 is a perspective view showing the tile spacer of FIG. 4 in use;

FIG. 6 is a plan view showing the tile spacer of FIG. 4 and another embodiment of the spacer in use; and

FIG. 7 is a schematic representation of the first or second embodiment of the tile spacer being used in an alternative mode.

### DETAILED DESCRIPTION OF THE DRAWINGS

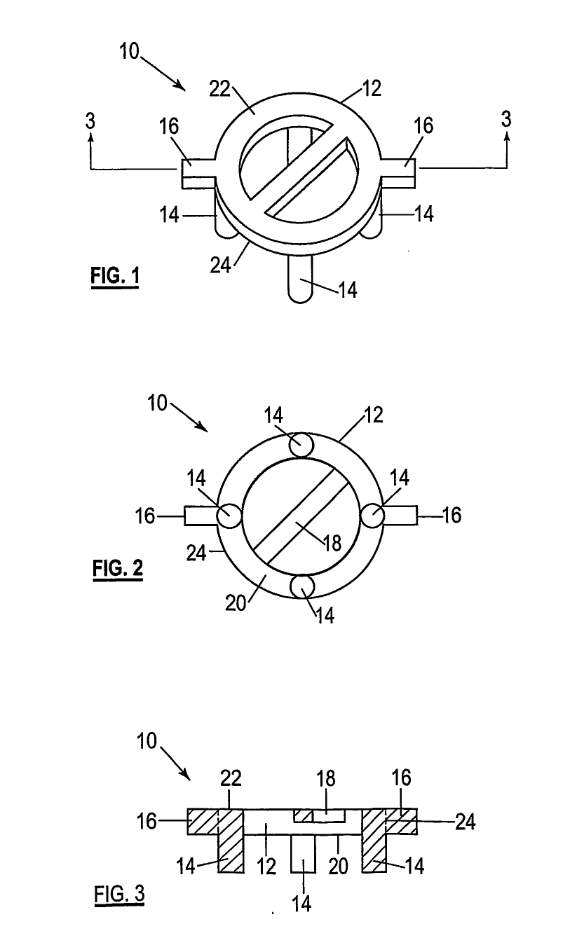

Referring to FIGS. 1 to 3, the tile spacer 10 comprises a circular annular support portion 12 from which four parallel first separator elements 14 and two opposed second separator elements 16 project. A bridge 18 extends diametrically across the annular support portion 12 to reinforce the support portion.

The support portion 12 has a planar lower face 20 from which the first separator elements 14 projection downwardly, perpendicularly thereto. The first separator elements 14 are in the form of pins having a circular cross section, conveniently with a diameter substantially the same as the width of the cross section of the support portion 12. The diameter of the pins is determined by their width along the annulus of the support portion because this is the minimum tile separation which will be defined by the separator elements 14. The width of the pins, and therefore the diameter of the circular separator elements 14, will generally be related to the size the tiles with which the tile spacer 10 will be used, but generally will be in the range about 1.5 to about 5 mm.

The first separator elements 14 are equally spaced around the support portion 12, and in use the tile spacer 10 will be disposed at the intersection of four rectangular tiles that are being laid, with each separator element 14 disposed between and abutting the opposed edges of a respective adjacent pair of tiles. Preferably, the first separator elements 14 have a height which is such that, when the lower face 20 of the support portion is supported on the exposed surface of each of the four tiles, the separator elements 14 do not project below the opposite surface of the tiles, that is the surface of the tiles being bonded to a support surface with tile adhesive. Again, this will be a function of the thickness of the tiles, but in the preferred embodiment the length of the first separator elements is about 6 mm. By this arrangement, the first separator elements will be above the level of the tile adhesive on which the tiles are laid. It is possible that some of the tile adhesive will be squeezed between the tiles as the tiles are correctly positioned, but the small length of the first separator elements in the radial direction of the support portion 12 and along the length of the opposed edges of the respective pair of adjacent tiles minimises the difficulty of removing the separator elements 14 from such adhesive.

As may be seen in FIG. 3, the reinforcing bridge 18 has a reduced depth compared to the support portion 12. This permits the fingertips of the tiler to engage the bridge 18 between the bridge and the exposed surfaces of the tiles to facilitate the removal of the tile spacer 10 from between the tiles. Thus, the bridge 18 acts as a handle even though the upper surface 22 of the tile spacer is planar. The hollow nature of the support portion 12 also permits the corners of the tiles beneath the support portion to be viewed as the tiles are being positioned.

The reinforcing bridge 18 is shown as extending from the support portion midway between adjacent pairs of the first separator elements 14, but it will be appreciated that the orientation of the reinforcing bridge 18 may be modified as desired during the design phase. Alternatively, in some embodiments, the reinforcing bridge may be omitted altogether if the support portion 12 has sufficient inherent strength. An undercut could then be provided in the support portion to facilitate gripping and removal of the tile spacer from between the tiles.

The second separator elements 16 project in opposed directions from a laterally outer face 24 of the support portion 12, radially of the support portion. As shown, the second separator elements 16 extend from locations immediately adjacent respective first separator elements 14, but this is not essential.

The second separator elements 16 have the same dimensions and shape as the first separator elements 14 and may be used individually where it is inconvenient to use the four first separator elements to space adjacent tiles. Alternatively, the second separator elements 16 may be used together, for example as shown schematically in FIG. 7 described hereinafter.

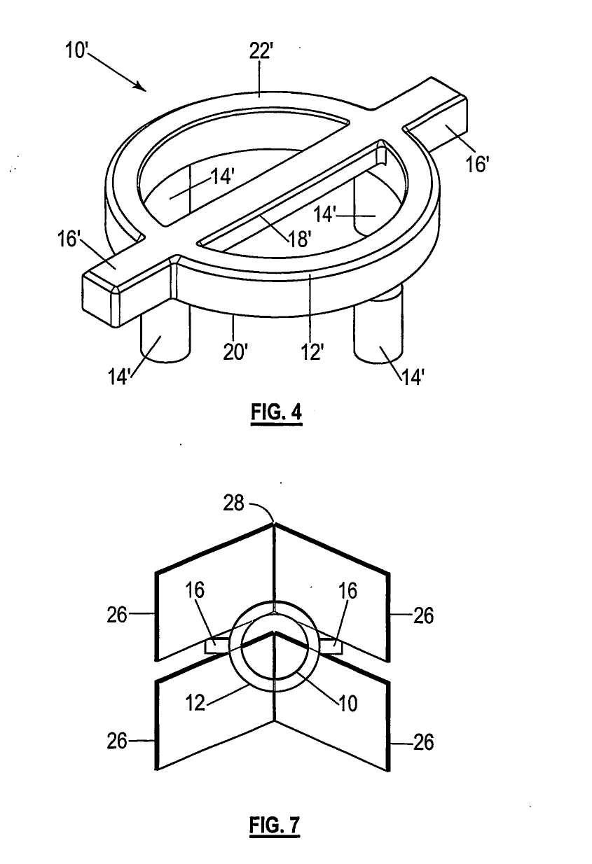

Referring now to FIG. 4, the tile spacer 10′ is very similar to the tile spacer 10 of FIGS. 1 to 3 and, for convenience only, will only be described in so far as it differs from the tile spacer 10. The same or similar parts of the tile spacer 10′ to those of the tile spacer 10 will be given the same reference numerals as in FIGS. 1 to 3, followed by a “′”.

In FIG. 4, the tile spacer 10′ is designed to provide a greater tile spacing than the tile spacer 10, so that the diameter of the first separator elements of 14′ is greater than that of the separator elements 14. To accommodate this, the first separator elements 14′ extend radially outwardly beyond the outer face 24′ of the support portion 12′.

The reinforcing bridge 18′ extends between the second separator elements 16′, and the second separator elements have a square cross section. Other then the square cross section, the second separator elements 16′ have the same size as the first separator elements 14′, as in the tile spacer 10.

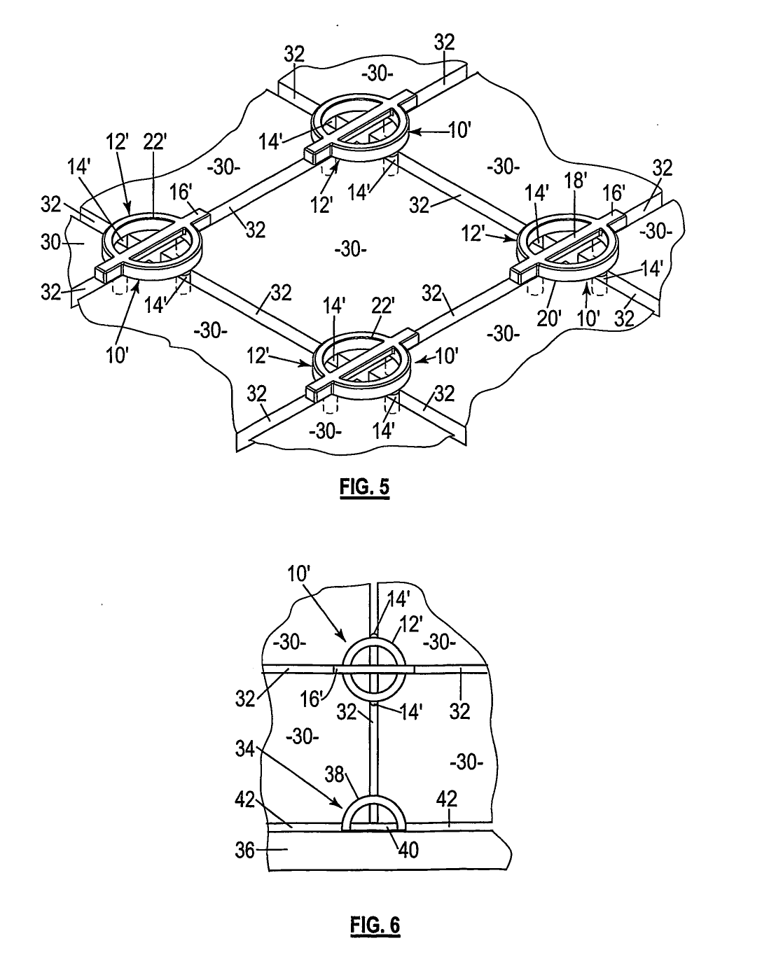

Four of the tile spacers 10′ of FIG. 4 are shown in use in FIG. 5, each spacing four tiles 30 having gaps 32 between them defined by the opposed side walls of adjacent tiles. Each tile spacer 10′ is therefore located at the juncture of the respective four of the tiles, with each of the first separator elements 14′ of that tile spacer abutting the side walls defining a respective one of the gaps 32. The annular support portion 12′ of each tile spacer 10′ sits on the respective four tiles and, in this condition, the first separator elements do not project below the level of the lower contact face (not shown) of the tiles that is adhered to a support surface. This and the relatively small length (along the gaps 32) of each first tile separator element alleviates the likelihood of the tile spacers becoming stuck in excess adhesive that is squeezed into the gaps 32 from between the contact surfaces of the tiles and the support surface. Providing a tile spacer 10′ at each corner of the tile ensures that the tiles extend parallel to each other.

Referring now to FIG. 6, another of the tile spacers 10′ of FIG. 4 is shown spacing four adjacent tiles in exactly the same way as in FIG. 5. Additionally, a further embodiment of the tile spacer 34 is shown spacing two tiles 30 from a wall 36.

The tile spacer 34 has a support portion 38 that is a D-shaped annulus defined by an arcuate section and a linear section 40 that extends parallel to the wall 36. The support portion has three depending tile spacer elements (not visible) that project from the support portion 38 midway along the arcuate section to abut the side walls of the two tiles 30 in the gap 32 and at respective ends of the arcuate section and of the linear section 40 to space each of those tiles 30 from the wall 36 in the respective gap 42.

Referring now to FIG. 7, either of the tile spacers 10 and 10′ may be used, but for convenience only the tile spacer 10 will be referred to. The tile spacer 10 is shown schematically in FIG. 7 with just the support portion 12 and the second separator elements 16.

In FIG. 7, two pairs of tiles 26 are being laid on respective surfaces (not shown) which meet at an internal corner 28. The tile spacer 10 is used to space the upper pair of tiles 26 from the lower pair of tiles, with each second separator element 16 disposed between the upper and lower tiles 26 on a respective one of these surfaces. In this use, the first separator elements 14 need perform no function, and they conveniently project outwardly away from the corner 28. In an alternative arrangement, the tile spacer 10 could be used as in FIG. 5 but with the spacer disposed horizontally so that the first separator elements 14 project upwardly or downwardly parallel to the axis of the corner 28.

Those skilled in the art will appreciate that the invention described herein is susceptible to variations and modifications other than those specifically described. It is to be understood that the invention includes all such variations and modifications which fall within its spirit and scope. The invention also includes all the steps and features referred to or indicated in this specification, individually or collectively, and any and all combinations of any two or more of said steps or features.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge.

1. A removable tile spacer comprising:
a support portion adapted to overlie at least one tile with a lower face of the support portion opposed to an exposed face of the at least one tile,
a plurality of individual first tile separator elements carried by the support portion and projecting downwardly relative to said lower face, and
optionally a handle,
wherein each of said first tile separator elements is spaced from the other first tile separator element or elements and has opposite surfaces which abut opposed edges of adjacent tiles in use to space said tiles, and
wherein said tile spacer is removable by gripping the support portion or optional handle and applying force to remove the first tile separator elements from between the tiles.

2. A tile spacer according to claim 1 having two spaced individual first tile separator elements.

3. A tile spacer according to claim 1 having three spaced individual first tile separator elements.

4. A tile spacer according to claim 1 having four spaced individual first tile separator elements.

5. A tile spacer according to claim 1 wherein the length of each first tile separator element is no greater than twice its width.

6. A tile spacer according to claim 5 wherein the length of each first tile separator element is no greater than its width.

7. A tile spacer according to claim 1 wherein the length of each first tile separator element is in the range of about 1.5 mm to about 10 mm.

8. A tile spacer according to claim 1 wherein the individual first tile separator elements project downwardly relative to said lower face in parallel to each other.

9. A tile spacer according to claim 1 wherein the individual first tile separator elements project from the lower face of the support portion.

10. A tile spacer according to claim 1 wherein the lower face of the support portion provides one or more reduced contact areas capable of abutting the exposed surface of the tile or tiles, compared to the overall area of the support portion.

11. A tile spacer according to claim 1 wherein the support portion comprises an annulus.

12. A tile spacer according to any one of claims 1 to 11 claim 1 which includes a handle.

13. A tile spacer according to claim 11 which includes an annulus, wherein the handle extends across the annulus.

14. A tile spacer according to claim 1 which includes one or more second tile separator elements that project laterally outwardly from the support portion.

15. A tile spacer according to claim 14 wherein there are two second tile separator elements that project laterally outwardly in opposite directions from the support portion.

16. A tile spacer according to claim 1 wherein the lower face of the support portion is planar.

17. A method of laying a tile on a support surface which comprises applying adhesive to one or both of a contact surface of the tile and the support surface, adhering the tile contact surface to the support surface, spacing the tile on the support surface relative to an adjacent surface by means of a tile spacer comprising a support portion that overlies the tile with a lower face of the support portion opposed to an exposed face of the tile, said exposed face being opposite the contact surface, and a plurality of spaced individual first tile separator elements carried by the support portion and projecting downwardly relative to said lower face with at least one of said first tile separator elements having opposite surfaces that respectively abut a side edge of the tile and said adjacent surface, and removing the tile spacer.

18. A method according to claim 17 wherein said adjacent surface is a side edge of a second tile.

19. A method according to claim 17 wherein the tile spacer is used at the juncture of two tiles with said adjacent surface, the tile spacer having three individual first separator elements that respectively space the two tiles, the first-mentioned tile and said adjacent surface, and the second of the two tiles and said adjacent surface.

20. A method according to claim 18 wherein the tile spacer is used at the juncture of four tiles, the tile spacer having four individual first separator elements that respectively space adjacent pairs of tiles.

21. A method according to claim 17 wherein each of the plurality of spaced individual first tile separator elements does not project beyond the contact surface of the or each tile when the lower face of the support portion abuts the exposed face of the or each tile.
